(19) United States
(12) Patent Application Publication
(10) Pub. No.: US 2016/0355687 A1
(43) Pub. Date: Dec. 8, 2016

(54) COATING COMPOSITION FOR GLITTER SHEET, PRINTABLE GLITTER SHEET USING THE SAME AND METHOD FOR MANUFACTURING THEREOF

(71) Applicant: Kyu Seong Hwang, Incheon (KR)

(72) Inventor: Kyu Seong Hwang, Incheon (KR)

(21) Appl. No.: 15/141,181

(22) Filed: Apr. 28, 2016

(30) Foreign Application Priority Data
Jun. 2, 2015 (KR) 10-2015-0077990

(51) Int. Cl. C09D 5/00; B41M 5/50; C09D 7/12; C09D 131/04; C09D 123/08

(52) U.S. Cl. CPC C09D 5/00; C09D 131/04; C09D 123/0853; C09D 7/1216; B41M 5/502; C08K 3/0033

(57) ABSTRACT

Embodiments of the present invention provide a coating composition for glitter sheets, which includes a glitter binder resin, glitter particles and porous particles, a glitter sheet using the same, and a method for manufacturing the same.

### CROSS-REFERENCE TO RELATED APPLICATION

This application claims priority to and the benefit of Korean Patent Application No. 10-2015-0077990, filed on Jun. 2, 2015 in the Korean Intellectual Property Office, the entire disclosure of which is incorporated herein by reference.

### FIELD OF THE INVENTION

Embodiments of the invention relate to a coating composition for glitter sheets, a printable glitter sheet fabricated using the same, and a method for manufacturing thereof.

### DESCRIPTION OF THE RELATED ART

A glitter sheet refers to a sheet that has glittering decorative properties and includes a coating layer formed on a surface thereof and containing glitter particles. Herein, the glitter particles generally refer to small flakes having reflectivity, and can realize a sparkling appearance, a shimmering appearance, and the like on a surface of an article by reflecting light at various angles.

Such a glitter sheet is used in various fields that require both pleasing decoration and properties of paper sheets. Specifically, glitter sheets are used in manufacture of wrapping products, crafts, decorative products, wallpapers, glitter cloths, advertising media, and the like.

A typical glitter sheet is manufactured by depositing a hot melt adhesive to a supporter, scattering glitter particles onto a surface of the hot melt adhesive layer, followed by heating to secure the glitter particles to the surface of the hot melt adhesive layer.

However, such a typical glitter sheet has problems such as very high roughness due to the glitter particles and easy detachment of the glitter particles, thereby causing damage to a printer. Moreover, the hot melt adhesive contains a wax component and thus exhibits very poor adhesion to a typical printer ink (water or oil-based ink). Accordingly, when the glitter sheet is printed with typical printer ink to form letters, patterns, figures, and the like thereon, there is a problem of ink spreading or erasing, which causes substantial printing failure.

In order to solve such problems in the related art, a curable ink is used to print on a glitter sheet instead of such a typical printer ink. Examples of the curable ink include a UV curable ink, a latex ink, and the like. However, the curable ink is very expensive due to polymer components therein and requires a curing apparatus, thereby causing high installation costs. Moreover, the curable ink has an unpleasant smell and is not beneficial to workers upon exposure to ultraviolet light in production thereof. In other words, a typical glitter sheet is difficult to print by a general printing method and requires an expensive special printer, thereby causing deterioration in economic feasibility.

Therefore, there is an increasing need for a technique capable of manufacturing a high quality glitter sheet at low cost through a simple process. Particularly, there is an increasing need for a glitter sheet coating technique which employs a typical print ink (water or oil-based ink) and can secure high quality printouts even when used in an inkjet printer, an offset printer, a laser printer, a gravure printer, a flexo-printer, a copying machine, and the like, which do not include a separate curing apparatus, thereby reducing manufacturing costs.

One example of the related art is disclosed in Korean Patent Laid-open Publication No. 2012-0049479.

### SUMMARY OF THE INVENTION

It is one object of the present invention to provide a coating composition capable of securing high quality printing on a glitter sheet while reducing manufacturing costs.

It is another object of the present invention to provide a coating composition, which secures good properties in terms of print quality of a water or oil-based ink, surface smoothness (coefficient of friction), gloss, adhesion, print resolution, and the like, and a glitter sheet manufactured using the same.

It is a further object of the present invention to provide a glitter sheet which secures good print quality even when printed using an inkjet printer, an offset printer, a laser printer, a gravure printer, a flexo-printer, a copying machine, and the like, which do not include a separate curing apparatus.

It is yet another object of the present invention to provide a coating composition for glitter sheets, which can impart good glitter adhesion, surface smoothness and ink printability to a glitter sheet through a simple process.

It is yet another object of the present invention to provide a coating composition for glitter sheets capable of minimizing generation of volatile organic compounds.

The above and other objects of the present invention can be achieved by embodiments of the invention described below

In accordance with one aspect of the present invention, a coating composition for glitter sheets includes: a glitter binder resin including at least one of vinyl acetate-ethylene resins, polyvinyl acetate resins, acrylic resins, styrene-butadiene rubber (SBR), nitrile rubber, acrylic rubber and urethane resins; glitter particles; and porous particles.

The coating composition for glitter sheets may include about 20 wt % to about 60 wt % of the glitter binder resin, about 10 wt % to about 60 wt % of the glitter particles, and about 1 wt % to about 30 wt % of the porous particles.

The porous particles may include at least one of silica particles, calcium silicate particles, calcium carbonate particles, calcium sulfate particles, alumina particles, aluminum silicate particles, kaolin particles, talc particles, mica particles, dolomite particles, plaster particles, clay particles, titanium oxide particles, and porous polymer particles.

The glitter binder resin may be a mixture of about 30 wt % to about 70 wt % of a first binder resin having a glass transition temperature of about 0° C. to about 70° C. and about 30 wt % to about 70 wt % of a second binder resin having a glass transition temperature of less than about 0° C. to about −50° C., and the coating composition for glitter sheets may have oil-based ink printability.

The coating composition for glitter sheets further comprises at least one hydrophilic resin selected from among polyvinyl alcohol, polyvinyl alcohol-acetate copolymers, polyvinyl pyrrolidone, water-soluble acrylic resins, starch, gelatin and cellulose resins; the glitter binder resin may be a mixture of about 45 wt % to about 95 wt % of a first binder resin having a glass transition temperature of about 0° C. to about 70° C. and about 5 wt % to about 50 wt % of a second binder resin having a glass transition temperature of less than about 0° C. to about −50° C.; and the coating composition for glitter sheets may have oil-based ink printability.

The coating composition for glitter sheets may further include at least one additive selected from among bonding aids, cationic color-fixing agents, crosslinking agents, dispersants, thickening agents, wetting agent, preserving agents, plasticizers, surfactants, diluting agents, antifoaming agents, lubricants, leveling agents, water repellents, UV stabilizers, anti-blocking agents, optical brightening agents, dyes, pigments, colorants, and pH regulators.

In accordance with another aspect of the present invention, a glitter sheet for printing includes a sheet supporter and a glitter coating layer formed on the sheet supporter, wherein the glitter coating layer comprises the coating composition as set forth above.

The glitter sheet for printing may further include an outermost coating layer formed on the glitter coating layer, wherein the outermost coating layer may include a glitter binder resin and porous particles.

The glitter sheet for printing may have a static coefficient of friction of about 0.2 to about 0.8 and a kinetic coefficient of friction of about 0.1 to about 0.5.

In accordance with a further aspect of the present invention, a method of manufacturing a glitter sheet includes depositing the coating composition as set forth above on a sheet supporter by roll coating, followed by drying the coating composition to form a glitter coating layer.

Embodiments of the invention provide a coating composition for glitter sheets, which can secure high quality printability of a glitter sheet and exhibits excellent properties in terms of oil-based ink printability, water-based ink printability, surface smoothness and adhesion, a glitter sheet using the same, and a method of manufacturing the same.

### BRIEF DESCRIPTION OF DRAWINGS

FIG. 1 is a sectional view of a glitter sheet according to one embodiment of the present invention, on which an oil-based ink is printed.

FIG. 2 is a sectional view of a glitter sheet according to one embodiment of the present invention, on which a water-based ink is printed.

### DETAILED DESCRIPTION OF THE INVENTION

Embodiments of the present invention provide a coating composition, a glitter sheet using the same, and a method of manufacturing the same, and will be described in detail.

<Coating Composition for Glitter Sheets>

Implementation 1

A first implementation of the present invention relates to a coating composition for glitter sheets (hereinafter, simply referred to as “coating composition”), which includes a glitter binder resin, glitter particles, and porous particles. With the coating composition, glitter sheets have improved affinity with ink, thereby securing high quality printing. In addition, the coating composition can simplify a process of forming a coating layer on a glitter sheet, thereby reducing manufacturing costs while improving productivity.

Specifically, the coating composition for glitter sheets according to the first implementation has good “ink printability”. As used herein, the term “ink printability” means that a glitter sheet allows printing with a water-based ink or an oil-based ink due to good adhesion and cohesion of the water-based ink or the oil-based ink to a surface of the glitter sheet. In addition, the expression ‘coating composition has ink printability’ means that the coating composition provides good ink printability to the glitter sheet. Here, printability means that figures, designs, letters, patterns and the like (hereinafter, commonly referred to as “images”) are clearly printed with high resolution without ink spreading. Further, “improvement of printability” means improvement in quick-drying properties, improvement in ink absorptiveness, improvement in print quality, improvement in resolution, improvement in image clarity, reduction in ink spreading, or the like.

More specifically, the coating composition for glitter sheets according to the first implementation may have excellent “oil-based ink printability”.

With these advantageous effects, the coating composition for glitter sheets can provide a glitter sheet capable of realizing high quality images even upon printing with an oil-based ink, such as inkjet printing, offset printing, laser printing, gravure printing, flexo-printing, copy printing, and the like. In this case, the glitter sheet can reduce printing costs by replacing an expensive curable ink with the oil-based ink. Further, the coating composition for glitter sheets can realize good image quality even using a typical printer (for example, an inkjet printer, an offset printer, a laser printer, a gravure printer, a flexo-printer, a copying machine, and the like) without a separate curing apparatus, thereby satisfying various consumer demands.

The glitter binder resin serves to bond glitter particles to a sheet supporter on which the coating composition will be deposited. Accordingly, it is possible to provide a glitter sheet in which the glitter particles are secured to the sheet supporter by a coating layer. As a result, the glitter particles are not detached from the sheet supporter during handling of the glitter sheet, thereby maintaining a glittering appearance. In addition, the coating composition may further include a colorant to provide a color to the glitter sheet, as needed.

In one embodiment, the glitter binder resin may include at least one selected from among vinyl acetate-ethylene resins, polyvinyl acetate resins, acrylic resins, styrene-acryl resins, styrene-butadiene rubber (SBR), nitrile rubber, acrylic rubber, and urethane resins. Accordingly, the glitter binder resin can exhibit good adhesion to both the sheet supporter and the glitter particles, while providing a high level of oil-based ink printability to the glitter sheet.

Specifically, the vinyl acetate-ethylene resins may be polyvinyl acetate-ethylene, modified polyvinyl acetate-ethylene or copolymers containing vinyl acetate-ethylene as a polymerization unit. The vinyl acetate-ethylene resin enhances ductility and plasticity of the coating layer while improving adhesion between the sheet supporter and the coating layer. In one example embodiment, poly(vinyl acetate-ethylene) may be used as the vinyl acetate-ethylene resin. According to this example embodiment, the glitter sheet can exhibit further improved oil-based ink printability. In another example embodiment, the copolymer containing vinyl acetate-ethylene as a polymerization unit may include a vinyl acetate-ethylene-acrylate terpolymer, a vinyl acetate-ethylene-vinyl chloride terpolymer, and the like. According to this example embodiment, the glitter sheet can exhibit further improved adhesion between the sheet supporter and the coating layer.

Specifically, the polyvinyl acetate resin may be polyvinyl acetate or modified polyvinyl acetate. The polyvinyl acetate resin can further improve handling properties and workability of the coating composition by improving quick-drying properties and flowability of the coating composition. In addition, when the quick-drying properties of the coating composition are improved, the coating composition can have further improved oil-based ink printability and print quality. In one example embodiment, polyvinyl acetate may be used as the polyvinyl acetate resin. According to this example embodiment, the glitter sheet can have further improved oil-based ink printability.

Specifically, the acrylic resin may be a non-modified acrylic resin. The non-modified acrylic resin can improve flexibility and waterproofness of the glitter sheet. In addition, the acrylic resin exhibits excellent permeability with respect to the sheet supporter, particularly, a paper sheet supporter, thereby further improving adhesion of the coating composition. In one example embodiment, the acrylic resin may be composed of 100% of polyacryl.

Specifically, the styrene-acryl resin may be a modified or non-modified copolymer containing a styrene monomer and an acryl monomer as polymerization units. The styrene-acryl resin can improve flexibility and waterproofness of the glitter sheet. In addition, the styrene-acryl resin can improve adhesion between the coating layer and the sheet supporter and smoothness of the coating layer.

Specifically, the styrene-butadiene rubber (SBR) may be a modified or non-modified styrene-butadiene rubber. The styrene-butadiene rubber can improve coating workability and initial adhesion of the coating composition.

Specifically, the nitrile rubber (NR) may be modified or non-modified nitrile rubber. In one example embodiment, the non-modified nitrile rubber may be used to improve oil-based ink printability of the glitter sheet.

Specifically, the acrylic rubber (AR) may be a modified or non-modified acrylic rubber, or a copolymer comprising acrylic rubber. More specifically, the copolymer comprising acrylic rubber may be a copolymer comprising the acrylic rubber (AR) and the nitrile rubber (NR), or a copolymer comprising an ethylene monomer and the acrylic rubber (AR). In one example embodiment, the non-modified acrylic rubber may be used, whereby the glitter sheet can have further improved oil-based ink printability.

Specifically, the urethane resin may be a modified or non-modified polyurethane. The modified or non-modified polyurethane can improve various properties of the glitter sheet such as freezing resistance, waterproofness, elasticity, deformation compliance, adhesion to the glitter particles, heat resistance, and the like. Further, the urethane resin allows the coating composition to maintain suitable strength after being formed into the coating layer.

In one embodiment, as the glitter binder resin, the resins as listed above may be used alone or as a mixture or copolymer thereof.

In one embodiment, as the glitter binder resin, a resin having an amorphous or crystal content of about 50% or less, for example, about 40% or less, or about 30% or less, may be used among the aforementioned resins. According to this embodiment, the coating layer formed after drying has further improved transparency, thereby further improving an outer appearance of the glitter sheet.

In one example embodiment, the glitter binder resin may be used in a resin emulsion state. Here, the resin emulsion may be any resin emulsion typically used in paper coating. When the glitter binder resin is used in an emulsion state, workability can be improved by suitably adjusting initial adhesion of the coating composition.

In one example embodiment, the glitter binder resin may be styrene-butadiene rubber (SBR), acrylic rubber, nitrile rubber, or a copolymer thereof. In this example embodiment, the resin may be used in a latex state. Here, the resin latex may be any typical resin latex without limitation. When the glitter binder resin is used in the latex state, workability can be improved by suitably adjusting initial adhesion and viscosity of the coating composition.

Specifically, the emulsion state glitter binder resin may be obtained from commercially available products or may be directly prepared by a typical method without limitation. As the glitter binder resin, the glitter binder resin emulsions as listed above may be used alone or as a mixture thereof.

In one example embodiment, when the glitter binder resin emulsion is directly prepared by a typical method, the glitter binder resin emulsion may be prepared by emulsifying any of the glitter binder resins as listed above in a dispersion medium. Here, the dispersion medium may be, for example, water, a hydrophilic solvent, an organic solvent, or mixtures thereof, and the resin may be present in an amount of, for example, 5% to 70% in the emulsion. Within this range, it is possible to obtain a resin emulsion capable of further improving workability of the coating composition.

In another example embodiment, when the glitter binder resin emulsion is directly prepared by a typical method, the glitter binder resin emulsion may be prepared through emulsion polymerization of raw materials (for example, monomers) of any of the glitter binder resins as listed above. Here, the resin may be present in an amount of, for example, 5% to 70%, in the emulsion. Within this range, it is possible to obtain a resin emulsion capable of further improving workability of the coating composition.

In one embodiment, the glitter binder resin may include a first binder resin and a second binder resin having different glass transition temperatures. According to this embodiment, it is possible to achieve good balance between fixation of the glitter particles and antifouling performance of the surface of the glitter sheet. Further, the first binder resin and the second binder resin may include two or more resins having different glass transition temperatures and pertaining to the same kind of resin, or two or more resins having different glass transition temperatures and pertaining to different kinds of resins.

In one example embodiment, both the first binder resin and the second binder resin may be polyvinyl acetate-ethylene resins (the same kind of resin) having different glass transition temperatures. In another example embodiment, the first binder resin may be polyvinyl acetate-ethylene and the second binder resin may be a polyurethane resin (different kinds of resins), and both resins may have different glass transition temperatures. As such, when the first binder resin and the second binder resin have different glass transition temperatures, it is possible to obtain improved balance of adhesion between the glitter particles, the glitter binder resin and the sheet supporter while improving surface stability after drying of the glitter sheet.

Specifically, the first binder resin includes at least one glitter binder resin having a glass transition temperature of about 0° C. to about 70° C. and the second binder resin includes at least one glitter binder resin having a glass transition temperature of less than about 0° C. to about −50° C. Within this temperature range, the glitter binder resin can secure further improved balance between fixation of the glitter particles (the degree of fixing the glitter particles within the sheet supporter and the coating layer) and surface stability of the glitter sheet.

As used herein, the term “surface of the glitter sheet” means a coating layer which is formed by depositing the coating composition according to the embodiments onto the sheet supporter, followed by drying. In other words, the surface of the glitter sheet means a state that the coating composition is applied to the glitter sheet.

Here, the term “surface stability of the glitter sheet” means a state of the glitter sheet wherein, after formation of the coating layer (after coating and drying of the coating composition) on the glitter sheet, contaminants are not attached to the surface of the glitter sheet due to adhesive strength of the binder, or part of the coating layer is not attached to instruments or other objects contacting the coating layer in the course of handling.

In one embodiment, the glitter binder resin may include about 30 wt % to about 70 wt % of the first binder resin and about 30 wt % to about 70 wt % of the second binder resin. Within this range, the glitter binder resin can secure further improved balance between fixation of the glitter particles, surface stability, oil-based ink printability and antifouling performance of the coating layer.

More specifically, the first binder resin and the second binder resin may be mixed in a weight ratio of about 1:1 to about 2:1. Within this range, the glitter sheet can have further improved oil-based ink printability.

In one embodiment, the first binder resin may have a viscosity at 25° C. of about 1,000 mPa·S to about 10,000 mPa·S. Specifically, the first binder resin may have a viscosity at 25° C. of about 1,000 mPa·S to about 6,000 mPa·S, for example, about 1,500 mPa·S to about 5,500 mPa·S. Within this range, affinity between the glitter sheet and the oil-based ink can be further improved, thereby improving oil-based ink printability and print quality of the glitter sheet. In addition, within this range, the coating composition can have further improved wettability and workability.

In one embodiment, the second binder resin may have a viscosity at 25° C. of about 500 mPa·S to about 6,000 mPa·S. Specifically, the second binder resin may have a viscosity at 25° C. of about 500 mPa·S to about 5,800 mPa·S, for example, about 1,000 mPa·S to about 4,000 mPa·S. Within this range, affinity between the glitter sheet and the oil-based ink can be further improved, thereby improving oil-based ink printability and print quality of the glitter sheet. In addition, within this range, the coating composition can have further improved wettability and workability.

In one embodiment, the glitter binder resin may have an overall viscosity of about 1,000 mPa·S to about 8,000 mPa·S (viscosity of a mixture of two or more binder resins, if used). Within this range, the coating composition can allow rigid fixation of the glitter particles in the sheet supporter while securing flowability.

In one embodiment, the glitter binder resin may be present in an amount of about 20 wt % to about 60 wt % in the coating composition for glitter sheets. Within this range, the coating composition can have suitable viscosity to improve handling performance while securing fixation of the glitter particles and anti-fouling performance of the coating layer.

Specifically, the glitter binder resin may be present in an amount of about 20 wt % to about 50 wt %, more specifically about 20 wt % to about 40 wt %, in the coating composition for glitter sheets. Within this range, the coating composition can secure fixation of the glitter particles while further improving anti-fouling performance of the coating layer. In addition, within this range, the coating composition allows the glitter particles to be suitably dispersed therein, thereby further improving glittering effects.

The glitter particles serve to realize an outer appearance of the glitter sheet. Specifically, each glitter particle reflects incident light in different directions, thereby realizing a glittering appearance.

In one embodiment, the glitter particles may include a transparent polymer film as a substrate of the glitter particle; and at least one layer of a metal deposition layer, a color printed layer, a hologram layer, and a rainbow layer. With such glitter particles, the glitter sheet can have a further improved appearance and can realize various aesthetic effects.

Specifically, the glitter particles may be prepared by forming a vacuum deposited metal film, a hologram layer, a metal powder coated layer, a color printed layer, a rainbow layer, a polymer coating layer, an aluminum deposited layer, a titanium dioxide layer, and the like on a substrate film. With this structure, the glitter particles can realize a glittering appearance and a shimmering appearance.

Specifically, the transparent polymer film may be used as a substrate for maintaining the shape of the glitter particles. For example, the transparent polymer film may include a polyester film, a polyvinyl chloride film, a polyolefin film, or other transparent polymer film. The polyolefin film may include a polypropylene film, a polyethylene film, and the like. The other transparent polymer film may include, for example, a polyacrylate film. Such a transparent polymer film exhibits excellent adhesion to the glitter binder resin according to the embodiments of the invention and excellent transparency, thereby improving appearance quality. More specifically, the transparent polymer film may have a thickness of about 20 μm to about 50 μm. Within this range, the glitter particles can provide good handling performance and can exhibit good adhesion to the coating composition.

Specifically, the metal deposition layer can further improve glittering effects by strongly reflecting light. Examples of metal for the metal deposition layer may include aluminum, gold, silver, and copper, without being limited thereto. Use of these metals can realize a very thin deposition layer and realize excellent glittering effects while reducing manufacturing costs. For example, the metal deposition layer may be formed on one or both surfaces of the transparent polymer film, on an upper or lower surface of the color printed layer, on one or both surfaces of the hologram layer, and on one or both surfaces of the rainbow layer, without being limited thereto.

Specifically, the color printed layer imparts a color to the glitter particles. The color printed layer is not limited to a particular color. For example, the color printed layer may be formed on one or both surfaces of the transparent polymer film, on one or both surfaces of the metal deposition layer, on one or both surfaces of the hologram layer, and on one or both surfaces of the rainbow layer, without being limited thereto.

Specifically, the hologram layer means a layer capable of realizing three-dimensional visual effects through adjustment of reflectivity or interference of light. With such a hologram layer, the glitter particles can have a pleasing appearance.

Specifically, the rainbow layer means a layer capable of converting incident light into a different color having a different index of refraction or different wavelengths from that of the incident light. With such a rainbow layer, the glitter particles can realize a rainbow color, an aurora color, and the like.

Specifically, the glitter particles may have a flake shape. The flake shape may include, for example, a circular flake shape, a star flake shape, a linear flake shape, a heart flake shape, a rectangular flake shape, and a hexagonal flake shape, without being limited thereto. When the glitter particles are produced in a flake shape, it is possible to secure smoothness and printability of the glitter sheet.

Specifically, the glitter particles may have a thickness of about 12 μm to about 150 μm, without being limited thereto.

In one example embodiment, the glitter particles may be produced by forming an aluminum deposited layer on one surface of a about 20 μm to about 50 μm thick transparent polymer film, and forming color printed layers on a rear surface of the polymer film and/or an upper surface of the deposited layer by an oil-based color printing method, followed by cutting the resulting stack into a flake shape.

In another example embodiment, the glitter particles may be produced by laminating a rainbow layer on one surface of a about 20 μm to about 50 μm thick transparent polymer film, followed by cutting the resulting stack into, for example, a circular flake shape, a hexagonal flake shape, and the like.

In a further example embodiment, the glitter particles may be produced by laminating a rainbow layer on one surface of a about 20 μm to about 50 μm thick transparent polymer film, and forming color printed layers on a rear surface of the polymer film and/or an upper surface of the rainbow layer by an oil-based color printing method, followed by cutting the resulting stack into, for example, a circular flake shape, a hexagonal flake shape, and the like.

More specifically, the glitter particles may have an average particle diameter of about 0.05 mm to about 10 mm, without being limited thereto. Within this range, fixation of the glitter particles can be further improved. The average particle diameter of the glitter particles can vary depending upon the outer appearance of the glitter sheet, as needed.

More specifically, the glitter particles may have an average area of about 0.002 mm² to about 160 mm², without being limited thereto. Within this range, fixation of the glitter particles can be further improved. The average area of the glitter particles can vary depending upon the outer appearance of the glitter sheet, as needed.

In one embodiment, the glitter particles may be present in an amount of about 2 wt % to about 60 wt % in the coating composition. Specifically, the glitter particles may be present in an amount of about 3 wt % to about 50 wt %, more specifically about 4 wt % to about 50 wt %, about 10 wt % to about 50 wt %, or about 15 wt % to about 50 wt %. Within this range, the glitter particles can be uniformly dispersed in the coating composition. Accordingly, the glitter sheet can have an improved appearance and can prevent the glitter particles from being detached therefrom during a process.

The porous particles serve to improve ink adsorptivity of the glitter sheet through pores. In this case, the porous particles included in the coating composition can adsorb ink in a state of being secured to the coating layer after formation of the coating layer. Accordingly, the porous particles prevent ink spreading by rapidly absorbing the ink and act as an anchor for immobilizing the ink to the surface of the glitter sheet, thereby improving print quality. In addition, the porous particles immobilize colorants to the surfaces of the particles until a solvent of the ink is volatilized, thereby preventing loss of the colorants. As a result, color density at a printing point can be increased, thereby improving print quality.

Further, the porous particles can improve viscosity of the coating composition. As a result, the glitter binder resin can sufficiently cover the glitter particles, thereby further improving fixation of the glitter particles. On the other hand, when the coating composition does not include the porous particles, there can be a problem of deterioration in ink printability (or print suitability) of the coating layer. Herein, the print suitability means, for example, print resolution, ink drying rate, degree of ink bleeding, and the like.

Further, the porous particles can be distributed in an empty space between the glitter particles. As a result, the coating layer can be formed more densely, thereby improving surface smoothness of the glitter sheet.

In one embodiment, the porous particles may include at least one particle selected from among silica particles, calcium silicate particles, calcium carbonate particles, calcium sulfate particles, alumina particles, aluminum silicate particles, kaolin particles, talc particles, mica particles, dolomite particles, plaster, clay particles, titanium oxide particles, and porous polymer particles. According to this embodiment, the porous particles can exhibit excellent ink adsorptivity while improving compatibility with the coating composition. As a result, the glitter sheet can have further improved surface smoothness and ink printability. Furthermore, the porous particles can prevent the porous particles or the glitter particles from precipitating by adjusting the viscosity of the coating composition. Further, the porous particles may also include derivatives or modified porous particles of the exemplary porous particles described above.

Specifically, the porous particles may be any particles without limitation so long as the particles have pores on surfaces thereof. For example, the porous particles may be selected from among gel type, precipitated type, fumed type, dry type, ground type, calcined type, and hydrous type porous particles, as needed.

In one example embodiment, the porous particles may be clay flakes. The clay flakes can provide excellent effects in terms of viscosity adjustment and precipitation prevention. Furthermore, the clay flakes can further improve surface smoothness of the glitter sheet.

In another example embodiment, the porous particles may be fumed silica. Fumed silica is more advantageous in formation of pores in the porous particles, thereby improving ink absorptiveness.

In a further example embodiment, the porous particles may be calcium carbonate. The calcium carbonate particles can provide excellent effects in terms of ink absorptiveness and drying performance. Furthermore, the calcium carbonate particles can improve surface smoothness of the glitter sheet.

In one embodiment, the porous particles may have an average particle diameter of about 0.1 μm to about 80.0 μm, specifically about 0.1 μm to about 70.0 μm, more specifically about 1.0 μm to about 60.0 μm, for example, about 2.5 μm to about 40.0 μm. Within this range, the coating layer allows ink to percolate directly at a contact position between the ink and the sheet and thus allows edges of printed designs, patterns, and letters to be more sharply and clearly implemented, thereby further improving print quality. Accordingly, the glitter sheet can exhibit further improved surface smoothness and ink printability.

In one embodiment, the porous particles as listed above may be used alone or in combination thereof. In this case, the coating layer can have improved ink absorptiveness and quick-drying properties. In addition, the glitter sheet can exhibit further improved surface smoothness and ink printability.

In one example embodiment, the porous particles may include both ground type calcium carbonate having an average particle diameter of about 0.1 μm to about 3.0 μm and precipitated calcium carbonate having an average particle diameter of about 3.5 μm to about 15.0 μm. Accordingly, the glitter sheet can exhibit further improved surface smoothness and ink printability. In addition, the glitter sheet can have further improved printability with standard inks, thereby improving writability with ink pens or the like.

In another example embodiment, the porous particles may include about 70 wt % of the ground type calcium carbonate having an average particle diameter of about 0.1 μm to about 3.0 μm, about 20 wt % of the precipitated calcium carbonate having an average particle diameter of about 3.5 μm to about 15.0 μm, and about 10 wt % of gel type silica. Accordingly, the glitter sheet can exhibit further improved surface smoothness and ink printability. In addition, the glitter sheet can have further improved printability with standard inks, thereby improving writability with ink pens or the like.

In one embodiment, the porous particles may have a specific surface area of about 2 m²/g to about 600 m²/g. Within this range, the porous particles can have further improved ink adsorptivity properties. Accordingly, the glitter sheet can exhibit further improved surface smoothness and ink printability.

In one embodiment, the porous particles may be subjected to surface treatment using cationic hydrophilic or hydrophobic surface treatment agents. Accordingly, the coating layer can have improved affinity with ink particles, thereby improving printability and quick-drying properties.

In one embodiment, the porous particles may be present in an amount of about 1 wt % to about 30 wt %, specifically about 5 wt % to about 25 wt %, more specifically about 5 wt % to about 20 wt % based on the total weight of the coating composition. Within this range, the coating layer can have further improved ink absorptiveness and quick-drying properties. Accordingly, the glitter sheet can exhibit further improved ink printability.

In one embodiment, the coating composition for glitter sheets may further include at least one additive selected from among bonding aids, cationic color-fixing agents, crosslinking agents, dispersants, thickening agents, wetting agent, preserving agents, plasticizers, surfactants, diluting agents, antifoaming agents, lubricants, leveling agents, water repellents, UV stabilizers, anti-blocking agents, optical brightening agents, dyes, pigments, colorants, and pH regulators.

Examples of the bonding aids may include crosslinking agents including ammonium compounds, zirconium carbonate compounds, zinc oxide, and the like; and silane coupling agents. In this case, the bonding aids can improve adhesive strength between components of the coating composition, and further improve fixation of the glitter particles and the porous particles. Accordingly, the glitter sheet can exhibit further improved ink printability

Specifically, the cationic color-fixing agents may be polymerizable cationic additives, polyelectrolytes, and the like. Specifically, the polymerizable cationic additives may include imine compounds, imide compounds, and cationic functional group-containing promoters. More specifically, the polymerizable cationic additives may include polydialkyldimethylammonium chloride (poly-DADMAC), zinc-ammonium carbonate, and the like. In this case, the coating layer can have excellent affinity with ink particles, thereby further improving ink printability. In addition, the coating layer can further increase density of ink at portions with images printed thereon as well as prevent loss of colorant particles in the ink over time after printing. For example, when ink containing anionic colorants is used, the coating composition for glitter sheets including the cationic color-fixing agent can exhibit further improved adhesion between the colorants and the glitter coating layer. As a result, the coating layer allows the pigments of the ink to be anchored to surfaces of the porous particles and allow a solvent to be absorbed into pores of the porous particles, thereby improving quick-drying properties.

Specifically, the dispersion agent may be typical suspending agents, microcrystalline cellulose (MCC), sodium polyacrylate, polyacrylate dispersion agents, nonionic surfactants, anionic surfactants, or sodium carbonate, without being limited thereto.

Specifically, the wetting agent may be ethylene glycol, diethylene glycol, triethylene glycol, propylene glycol, sorbitol, or glycerin, without being limited thereto.

Specifically, the coating composition may include, without being limited to, any typical thickeners, preservatives, plasticizers, surfactants, diluents, defoamers, lubricants, leveling agents, water repellents, UV stabilizers, anti-blocking agents, optical brightening agents, and pH regulators without affecting compatibility of the composition.

Specifically, the additives may be present in an amount of about 0.1 wt % to about 10 wt % in the coating composition. Within this range, the coating layer can exhibit increased adhesion and surface stability after coating while improving effects of the additives.

In one example, the coating composition for glitter sheets may further include a colorant. The colorant is added to impart color to the glitter sheet and may include pigments, dyes, and the like. Examples of the colorant may include fluorescent dyes, fluorescent pigments, phosphorescent pigments, aqueous pigments, aqueous dyes, pearl pigments, and the like. The pearl pigments may be, for example, pearl mica pigments. Here, mica particles of the pearl mica pigments are different from the mica particles available as the porous particles as described above and are used to realize a color of the pearl pigments. In one example embodiment, when used in equal amounts in the glitter coating layer, the dyes provide better improvement in gloss than the pigments.

Specifically, the colorant may be present in an amount of about 0.1 wt % to about 50 wt % in the composition. Within this range, the colorant can further improve gloss of the glitter coating layer together with an outer appearance of the glitter sheet.

Implementation 2

A second implementation of the present invention relates to a coating composition for glitter sheets (hereinafter, simply referred to as “coating composition”), which includes a glitter binder resin, glitter particles, porous particles, and a water-based ink-philic resin solution. With the coating composition, glitter sheets have improved affinity with a water-based ink, thereby securing high quality printing. Accordingly, it is possible to minimize generation of volatile organic compounds in manufacture of the glitter sheets. In addition, the coating composition can simplify a process of forming a coating layer on a glitter sheet, thereby reducing manufacturing costs while improving productivity.

Specifically, the coating composition for glitter sheets according to the second implementation has “water-based ink printability”. As used herein, the term “water-based printability” means that a glitter sheet allows printing with a water-based ink due to good adhesion and cohesion of the water-based ink to a surface of the glitter sheet. In addition, the expression ‘coating composition has water-based ink printability’ means that the coating composition provides good water-based ink printability to the glitter sheet. Here, printability means that figures, designs, letters, patterns and the like (hereinafter, commonly referred to as “images”) are clearly printed with high resolution without ink spreading. Further, “improvement of printability” means improvement in quick-drying properties, improvement in ink absorptiveness, improvement in print quality, improvement in resolution, improvement in image clarity, reduction in ink spreading, or the like.

More specifically, the coating composition for glitter sheets according to the second implementation may have excellent “water-based ink printability”.

With these effects, the coating composition for glitter sheets can provide a glitter sheet capable of realizing high quality images even upon printing with a water-based ink, such as inkjet printing, offset printing, laser printing, gravure printing, flexo-printing, copy printing, and the like. In this case, the glitter sheet can reduce printing costs by replacing an expensive curable ink with the water-based ink. Further, the coating composition for glitter sheets can realize good image quality even in the case of using a typical printer (for example, an inkjet printer, an offset printer, a laser printer, a gravure printer, a flexo-printer, a copying machine, and the like) without a separate curing apparatus, thereby satisfying various consumer demands.

The glitter binder resin serves to bond glitter particles to a sheet supporter on which the coating composition will be deposited, while imparting water-based ink printability to the glitter sheet. Accordingly, the coating composition can impart high durability and a high level of water-based ink printability to the glitter sheet while maintaining a glittering appearance of the glitter sheet. Accordingly, the glitter particles are not detached from the sheet supporter during handling of the glitter sheet, thereby maintaining a glittering appearance. In addition, the coating composition may further include a colorant to impart a color to the glitter sheet, as needed.

In one embodiment, the glitter binder resin may include at least one selected from among vinyl acetate-ethylene resins, polyvinyl acetate resins, acrylic resins, styrene-acryl resins, styrene-butadiene rubber (SBR), nitrile rubber, acrylic rubber, and urethane resins. Accordingly, the glitter binder resin can exhibit good adhesion to both the sheet supporter and the glitter particles, while providing a high level of water-based ink printability to the glitter sheet. In addition, the glitter binder resin can exhibit good adhesion to both a paper sheet supporter and the glitter particles, while providing a high level of printability to the glitter sheet.

Specifically, vinyl acetate-ethylene resin may be polyvinyl acetate-ethylene, modified polyvinyl acetate-ethylene or copolymers containing vinyl acetate-ethylene as a polymerization unit. The vinyl acetate-ethylene resin enhances ductility and plasticity of the coating layer while improving adhesion between the sheet supporter and the coating layer. In one example embodiment, modified poly(vinyl acetate-ethylene) may be used as the vinyl acetate-ethylene resin. According to this example embodiment, the glitter sheet can exhibit further improved water-based ink printability due to high affinity between modified functional groups of the polyvinyl acetate-ethylene and the water-based ink. In another example embodiment, the copolymer containing vinyl acetate-ethylene as a polymerization unit may include a modified vinyl acetate-ethylene-acrylate terpolymer, a modified vinyl acetate-ethylene-vinyl chloride terpolymer, and the like. According to this example embodiment, the glitter sheet can exhibit further improved properties in terms of adhesion between the sheet supporter and the coating layer and water-based ink printability of the glitter sheet.

Specifically, the polyvinyl acetate resin may be polyvinyl acetate or modified polyvinyl acetate. The polyvinyl acetate resin can further improve handling properties and workability of the coating composition by improving quick-drying properties and flowability of the coating composition. In addition, when the quick-drying properties of the coating composition are improved, the coating composition can have further improved oil-based ink printability and print quality. In one example embodiment, modified polyvinyl acetate may be used as the polyvinyl acetate resin. According to this example embodiment, the glitter sheet can have further improved water-based ink printability due to high affinity between modified functional groups of the polyvinyl acetate and the water-based ink.

Specifically, the acrylic resin may be a modified acrylic resin. The modified acrylic resin can improve water-based ink printability of the glitter sheet. The modified acrylic resin exhibits further improved affinity between modified functional groups thereof and the water-based ink, whereby the glitter sheet can exhibit further improved water-based ink printability. In addition, the modified acrylic resin exhibits excellent wettability with respect to the sheet supporter, thereby further improving adhesion of the coating composition. In one example embodiment, the acrylic resin may be composed of about 100% polyacryl.

Specifically, the styrene-acryl resin may be a modified or non-modified copolymer containing a styrene monomer and an acryl monomer as polymerization units. The styrene-acryl resin can improve flexibility and waterproofness of the glitter sheet. In addition, the styrene-acryl resin can improve adhesion between the coating layer and the sheet supporter and smoothness of the coating layer.

Specifically, the styrene-butadiene rubber (SBR) may be a modified or non-modified styrene-butadiene rubber. The styrene-butadiene rubber can improve coating workability and initial adhesion of the coating composition.

Specifically, the nitrile rubber (NR) may be a modified nitrile rubber. In one example embodiment, the non-modified nitrile rubber may be used to improve water-based ink printability of the glitter sheet.

Specifically, the acrylic rubber (AR) may be a modified or non-modified acrylic rubber. In addition, a copolymer of the acrylic rubber and the nitrile rubber may be used. More specifically, the copolymer comprising acrylic rubber may be a copolymer comprising the acrylic rubber (AR) and the nitrile rubber (NR), or a copolymer comprising an ethylene monomer and the acrylic rubber (AR). In one example embodiment, the non-modified acrylic rubber may be used to further improve water-based ink printability of the glitter sheet.

Specifically, the urethane resin may be a modified or non-modified polyurethane. The modified or non-modified polyurethane can improve various properties of the glitter sheet such as freezing resistance, waterproof, elasticity, deformation compliance, adhesion to the glitter particles, heat resistance, and the like. Further, the urethane resin allows the coating composition to maintain suitable strength after being formed into the coating layer.

Herein, in the description of the glitter binder resin, the modified resins (for example, modified polyvinyl acetate-ethylene, modified (meth)acryl, and the like) means resins substituted with a hydrophilic functional group. Here, examples of the hydrophilic functional group may include a hydroxyl group, an amino group, and a carboxylate group, without being limited thereto. Use of such a modified resin can improve affinity between the glitter binder resin and the sheet supporter to allow the glitter binder resin to be easily permeated into the sheet supporter while improving water-based ink printability. Accordingly, the glitter sheet can achieve further improvement not only in cohesion and adhesion between the coating layer and the sheet supporter, but also water-based ink printability thereof. Further, use of the modified resin can improve ink affinity and adhesion of the coating composition, thereby allowing reduction in amount of the glitter binder resin. In one example embodiment, the glitter binder resin may be amino group or carboxylate group-substituted polyvinyl acetate-ethylene. According to this example embodiment, cohesion between the sheet supporter and the coating layer and between the glitter particles and the coating layer can be further improved.

The amount of the modified resin and the degree of substitution of the modified resin with the hydrophilic functional group may be adjusted by taking into account the amounts, kinds, compatibility, adhesive strength, and the like of the components included in the coating composition, as needed.

In one embodiment, as the glitter binder resin, the resins as listed above may be used alone or as a mixture or copolymer thereof.

In one embodiment, the glitter binder resin may be used in a resin emulsion state. Here, the resin emulsion may be any resin emulsion typically used in paper coating. When the glitter binder resin is used in an emulsion state, workability can be improved by suitably adjusting initial adhesion of the coating composition.

Specifically, the emulsion state glitter binder resin may be obtained from commercially available products or may be directly prepared by any typical method. As the glitter binder resin, the glitter binder resin emulsions as listed above may be used alone or as a mixture thereof.

In one embodiment, when the glitter binder resin emulsion is directly prepared by a typical method, the glitter binder resin emulsion may be prepared by emulsifying any of the glitter binder resins as listed above in a dispersion medium. Here, the dispersion medium may include, for example, water, a hydrophilic solvent, and the like, and the resin may be present in an amount of, for example, about 5% to about 50% in the emulsion. Within this range, it is possible to obtain a resin emulsion capable of further improving workability of the coating composition.

In another embodiment, when the glitter binder resin emulsion is directly prepared by a typical method, the glitter binder resin emulsion may be prepared through emulsion polymerization of raw materials (for example, monomers) of any of the glitter binder resins as listed above. Here, the resin may be present in an amount of, for example, about 5% to about 50%, in the emulsion. Within this range, it is possible to obtain a resin emulsion capable of further improving workability of the coating composition.

In one example embodiment, the glitter binder resin may be a mixture of polyvinyl acetate-ethylene and polyurethane. According to this example embodiment, the coating composition can exhibit excellent effects in fixation of the glitter particles to the coating layer and adhesion between the coating layer and the sheet supporter, while improving ductility of the coating layer.

In another example embodiment, the glitter binder resin may be a resin emulsion mixture of modified polyvinyl acetate-ethylene and an acrylic resin. According to this example embodiment, the coating composition can exhibit excellent effects in fixation of the glitter particles to the coating layer and adhesion between the coating layer and the sheet supporter.

In one embodiment, the glitter binder resin may include a first binder resin and a second binder resin having different glass transition temperatures. According to this embodiment, it is possible to achieve good balance between fixation of glitter particles and antifouling performance of a surface of the glitter sheet. Further, the first binder resin and the second binder resin may include two or more resins having different glass transition temperatures and pertaining to the same kind of resin, or two or more resins having different glass transition temperatures and pertaining to different kinds of resins.

In one example embodiment, both the first binder resin and the second binder resin may be polyvinyl acetate-ethylene resins (the same kind of resin) having different glass transition temperatures. In another example embodiment, the first binder resin may be polyvinyl acetate-ethylene and the second binder resin may be a polyurethane resin (different kinds of resins), and both resins may have different glass transition temperatures. As such, when the first binder resin and the second binder resin have different glass transition temperatures, it is possible to obtain improved balance of adhesion between the glitter particles, the glitter binder resin and the sheet supporter while improving surface stability after drying of the glitter sheet.

Specifically, the glitter binder resin may be a mixture of about 70 wt % to about 95 wt % of the first binder resin having a glass transition temperature of about 0° C. to about 70° C. and about 5 wt % to about 30 wt % of the second binder resin having a glass transition temperature of less than about 0° C. to about −50° C. Within this temperature range, the glitter binder resin can secure further improved balance between fixation of the glitter particles, surface stability, water-based ink printability, and anti-fouling performance of the coating layer.

More specifically, the first binder resin and the second binder resin may be mixed in a weight ratio of about 3:1 to about 5:1, for example, about 4:1. Within this range, the glitter sheet can have further improved water-based ink printability.

The water-based ink-philic resin solution serves to improve affinity between the glitter sheet and ink, particularly, a water-based ink. Accordingly, the glitter sheet has good effects in binding and absorption of the ink, thereby realizing a high quality image upon printing.

In one embodiment, the water-based ink-philic resin solution may contain at least one hydrophilic resin selected from among polyvinyl alcohol, polyvinyl alcohol-acetate copolymers, polyvinyl pyrrolidone, a water-soluble acrylic resin, starch, gelatin and cellulose resins. Accordingly, the glitter sheet can realize high quality water-based ink printability.

Specifically, the polyvinyl alcohol may include, for example, hydrolyzed polyvinyl alcohol (PVA). More specifically, about 86% or more, about 90% or more, or about 98% or more hydrolyzed polyvinyl alcohol may be used. In one example embodiment, about 100% hydrolyzed polyvinyl alcohol may be used. Accordingly, the coating composition can have further improved affinity with the water-based ink. In a further example embodiment, about 91% to about 96.5% hydrolyzed polyvinyl alcohol may be used. In yet another example embodiment, about 86% to about 89% hydrolyzed polyvinyl alcohol may be used. Accordingly, the polyvinyl alcohol can further improve water-based ink printability, thereby improving compatibility with other components. In addition, the coating layer can exhibit excellent water resistance after drying.

Specifically, polyvinyl pyrrolidone can improve contact angle with an ink upon printing by regulating interface characteristics of the coating layer. Accordingly, the coating composition can have improved ink printability and quick-drying properties.

Specifically, the cellulose resin may include, for example, a hydroxy ethylcellulose resin. The cellulose resin can further improve adhesion to the sheet supporter, particularly, a paper sheet supporter.

Specifically, the hydrophilic resin may be a modified resin (for example, a modified polyvinyl alcohol and the like). The definition of the modified resin is the same as that described above. Use of the modified resin can further improve adhesion between a hydrophilic functional group and the water-based ink, whereby the coating composition can realize a high level of water-based ink printability.

Specifically, the hydrophilic resin may be used alone or as a mixture thereof. In one example embodiment, the hydrophilic resin may include polyvinyl alcohol and polyvinyl pyrrolidone. According to this example embodiment, the coating composition can have improved water-based ink printability and quick-drying properties. Here, in the hydrophilic resin, the polyvinyl alcohol and polyvinyl pyrrolidone may be present in a weight ratio of about 8:2 to about 9:1. Within this range, the coating composition can exhibit further improved affinity with respect to a water-based ink for general inkjet printing, thereby realizing a high level of water-based ink printability.

Specifically, the hydrophilic resin may be mixed with a solvent to be used as a hydrophilic resin solution. Accordingly, adhesion between the water-based ink-philic resin solution and the sheet supporter and between the coating layer and the water-based ink can be further improved.

Specifically, as the solvent used in the water-based ink-philic resin solution, any solvent having good compatibility with the coating composition and securing good solubility of resins included in each solution can be used without limitation. For example, the solvent of a solution containing the hydrophilic resin may be water, a hydrophilic solvent, and the like. Accordingly, the coating composition can improve solubility of resins included in each solution while maintaining adhesion between the coating composition and the sheet supporter in a suitable level. More specifically, the solvent as listed above may be used alone or as a mixture thereof.

In one example, the ink-philic resin solution may be an aqueous solution containing the hydrophilic resin in a concentration of about 1% to about 100%, specifically about 1% to about 20%, more specifically about 1% to about 10%. Within this range, the coating composition further improves coatability and is advantageous in terms of viscosity regulation.

Specifically, the hydrophilic resin may have a weight average molecular weight (Mw) of about 1,000 g/mol to about 17,000 g/mol. More specifically, the hydrophilic resin may have a weight average molecular weight of about 3,000 g/mol to about 17,000 g/mol, still more specifically about 5,000 g/mol to about 17,000 g/mol. Within this range, the ink-philic resin solution can improve adhesion between a paper supporter and the coating layer while improving fixing of the glitter particles.

In one example embodiment, the ink-philic resin solution may be present in an amount of about 1 wt % to about 30 wt %, specifically about 1 wt % to about 25 wt %, more specifically about 1 wt % to about 20 wt %, in the coating composition. Within this range, the coating composition can further improve water-based ink printability of the glitter sheet.

The glitter particles and the porous particles applied to the coating composition according to the second implementation are the same as those of the coating composition according to the first implementation, and thus detailed description thereof will be omitted. Further, descriptions of additives that may be further added to the coating composition according to the second implementation are the same as those of the aforementioned additives.

In one embodiment, the glitter particles and the porous particles may be present in a total amount of about 40 wt % to about 75 wt % in the coating composition according to the above implementations (the first implementation and the second implementation). Within this range, the coating composition has high solid content to reduce drying calorie, and can reduce power consumption in a manufacturing process and manufacturing costs. Further, the coating composition can allow high production speed, thereby improving productivity while reducing production costs.

In one embodiment, the coating composition according to the above implementations may be prepared by introducing the components described above into a stirring machine, followed by stirring, without being limited thereto. Specifically, stirring may be performed in the stirring machine at about 100 rpm to about 1,000 rpm for about 30 minutes to about 1 hour. Accordingly, the glitter particles can be sufficiently wetted by other components included in the coating composition, and can be uniformly covered with a binder resin. As a result, the coating layer has improved smoothness and can suppress formation of bubbles. In one example embodiment, during stirring of the coating composition, a thickening agent may be added to the coating composition to adjust a dispersed state of the glitter particles within the coating composition while suitably changing flowability of the coating composition by adjusting viscosity of the coating composition.

<Glitter Sheet for Printing>

A further implementation of the present invention relates to a glitter sheet that includes a coating layer formed of the coating composition as described above to provide high print quality.

The glitter sheet includes a sheet supporter and a coating layer. As described above, the coating layer is formed of a coating composition for glitter sheets that includes a glitter binder resin, glitter particles and porous particles; or a coating composition that includes a glitter binder resin, a water-based ink-philic resin solution, glitter particles and porous particles, as described above.

Specifically, the sheet supporter may include paper, plastic media, cloths, and the like.

More specifically, the sheet supporter may be a paper sheet supporter having a weight of about 30 g/m² to about 300 g/m², without being limited thereto. In one example embodiment, when the paper sheet supporter having a weight of about 60 g/m² to about 250 g/m² is used, the glitter sheet may be advantageously applied to wrapping papers, cutting craft papers, folding craft papers, cards, postcards, wallpapers, ornamental papers, advertising media, and the like. In another example embodiment, when the paper sheet supporter having a weight of about 100 g/m²to about 150 g/m² is used, the glitter sheet may be advantageously applied to glitter cloths and the like.

More specifically, the sheet supporter may be plastic media having a thickness of about 100 μm to about 250 μm, without being limited thereto. In one example embodiment, when plastic media having a thickness of about 120 μm to about 200 μm is used, the plastic media may be advantageously applied to advertising media and the like.

More specifically, the sheet supporter may be a glitter cloth having a weight of about 50 g/m² to about 500 g/m², without being limited thereto. In this case, the glitter cloth is laminated on a paper sheet or film having a weight of about 50 g/m² to about 500 g/m² to be applied to wallpapers, craft papers, and the like. The coating layer may be formed by a suitable sheet coating method typically used in the art, without being limited thereto.

A conventional glitter sheet is manufactured by coating one surface of a sheet with a hot melt adhesive to form a hot melt adhesive layer, scattering glitter particles on the adhesive layer to form an adhesive layer, followed by drying the adhesive layer. This method requires an additional process of removing unattached glitter particles from the adhesive layer through vacuum suction, thereby causing a complicated process. Moreover, since the hot melt adhesive lacks fixability (fixing performance) of the glitter particles, the glitter particles can be easily detached from the glitter sheet. As a result, the glitter sheet has reduced utility due to easy detachment of the glitter particles. For example, when the glitter sheet is applied to a wrapping paper or the like, the glitter particles can be detached from the glitter sheet due to an adhesive tape for wrapping, thereby deteriorating wrapping performance. In addition, when the glitter sheet is applied to a glitter paper bag, a glitter box, and the like, a bonded portion of the glitter sheet can be detached together with the glitter particles, thereby causing deterioration in bonding performance.

Further, in such a conventional glitter sheet, the glitter particles has a particle diameter of about 50 μm to about 10,000 μm or a particle diameter of about 100 μm to about 3,000 μm, whereby a non-uniform surface having a width and length of about 90 μm to about 2,500 μm can be formed on the glitter sheet. Such a non-smooth surface has high roughness and is difficult to print by inkjet printing, offset printing, laser printing, gravure printing, flexo-printing, copy printing, and the like using an oil-based ink or a water-based ink.

A method of forming a coating layer according to one embodiment may be a process of coating the coating composition on the sheet supporter once. According to this embodiment, the coating layer can be formed through a single process, thereby further improving process convenience and cost efficiency, as compared with the conventional method which includes depositing a hot melt adhesive (corresponding to the binder of the present invention) and scattering glitter particles.

Specifically, the method of forming a coating layer may be a process of depositing the coating composition on the sheet supporter, followed by drying the coating composition. Here, coating may be performed by, for example, sheet coating, roll coating, roll-to-roll coating, sheet-to-roll coating, slow die-coating, comma coating, and the like. More specifically, the coating layer may be formed by sheet coating or roll coating.

More specifically, the coating layer may be formed by depositing the coating composition on one surface of the sheet supporter by roll coating in an apparatus including winding rolls and the like, followed by drying in a drying chamber and the like.

Specifically, drying temperature may be higher than or equal to the glass transition temperature of the binder resin included in the coating composition. More specifically, the drying temperature may be adjusted depending upon the glass transition temperature or minimum film formation temperature. For example, the drying temperature may be a medium temperature between the glass transition temperature and the minimum film formation temperature, or higher than the glass transition temperature. In this case, the method may further include an embossing process using a mirror embossing roller after formation of the coating layer, thereby further improving smoothness of the glitter sheet. Furthermore, it is possible to allow the embossing process to be suitably performed by an in-line process or an off-line process through adjustment of the drying temperature.

In some examples, the drying temperature may be about 50° C. to about 255° C., or about 100° C. to about 220° C. In addition, for example, drying may be performed for about 0.5 minutes to about 10 minutes, specifically about 0.5 minutes to about 3 minutes, without being limited thereto. For example, the coating layer may be formed by continuous roll coating using a roll coater in a coating amount of about 20 g/m² to about 100 g/m² in terms of solid content.

In some examples, embossing may be performed through pressure adjustment such that the coating layer has a thickness of about 50% to about 80%.

In some examples, embossing may be performed in an in-line process and may be separately performed through an off-line process. When embossing is performed in the in-line process, it is possible to achieve effective reduction of manufacturing costs through process simplification. When embossing is performed in the off-line process, it is possible to achieve further improvement in convenience of the embossing process.

In one embodiment, the method of manufacturing a glitter sheet may include coating the coating composition according to the present invention on a sheet supporter (coating target) in a roll state. In addition, for evaporation of solvents, the method may include heat drying by heating the coating compositing to a temperature higher than or equal to the glass transition temperature of the coating composition and minimum film formation temperature. As a result, the glitter particles having a high specific weight are settled in the binder resin during evaporation of the solvents, thereby achieving improvement in fixation of the glitter particles and smoothness of the glitter sheet.

In addition, before the coating layer is completely cooled and rewound after heat drying, the coating layer may be subjected to embossing using a mirror embossing roller to further improve surface smoothness and gloss of the glitter sheet. As a result, the glitter sheet can have further improved printability and prevent detachment of the glitter particles by further improving adhesion and cohesion of the binder and the glitter particles.

In one embodiment, the glitter sheet can adjust smoothness of the coating layer. Accordingly, the glitter sheet can further improve print quality. In one example embodiment, when the glitter sheet has good smoothness, it is possible to achieve further improvement in print quality and handling performance such as workability, winding performance, and the like.

The surface smoothness may be evaluated based on a coefficient of friction. A lower coefficient of friction indicates better surface smoothness. Specifically, the smoothness of the glitter sheet can be evaluated by measuring a static coefficient of friction of a glitter coating layer or an outermost coating layer.

Specifically, the glitter sheet according to the present invention has a static coefficient of friction of about 0.8 or less, for example, about 0.2 to about 0.8, more specifically about 0.7 or less, for example, about 0.2 to about 0.7. In addition, specifically, the glitter sheet according to the present invention has a kinetic coefficient of friction of about 0.5 or less, for example, about 0.1 to about 0.5, more specifically about 0.4 or less, for example, about 0.1 to about 0.4. Within this range, the glitter sheet exhibits excellent surface smoothness, thereby securing effects of further improving printability and preventing failure of a printer.

In one embodiment, the glitter sheet may further include an outermost coating layer (secondary coating) formed on the coating layer. The outermost coating layer may be formed of an outermost layer coating composition, which is composed of the components of the coating composition excluding the glitter particles. Specifically, the outermost layer coating composition includes a glitter binder resin and porous particles. The glitter binder resin and the porous particles of the outermost layer coating composition are the same as those of the coating composition described above, and thus detailed descriptions of these components is omitted herein. Specifically, like the coating composition described above, oil-based ink printability or water-based ink printability of the outermost layer coating composition can be adjusted by changing the components thereof, as needed.

In one embodiment, the outermost layer coating composition may include about 50 wt % to about 90 wt % of the glitter binder resin and about 10 wt % to about 50 wt % of the porous particles.

In one example embodiment, the outermost layer coating composition exhibits oil-based ink printability, and the glitter binder resin of the outermost layer coating composition may be a mixture of about 10 wt % to about 90 wt % of a first binder resin having a glass transition temperature of about 0° C. to about 70° C. and about 10 wt % to about 90 wt % of a second binder resin having a glass transition temperature of less than about 0° C. to about −50° C.

In another example embodiment, the outermost layer coating composition exhibits water-based ink printability, and the glitter binder resin of the outermost layer coating composition may be a mixture of about 30 wt % to about 50 wt % of the first binder resin having a glass transition temperature of about 0° C. to about 70° C., about 10 wt % to about 30 wt % of a second binder resin having a glass transition temperature of less than about 0° C. to about −50° C., and about 30% to about 50% of a hydrophilic resin.

In one embodiment, the outermost layer coating composition may further include at least one additive selected from among bonding aids, cationic color-fixing agents, crosslinking agents, dispersants, thickening agents, wetting agents, preserving agents, plasticizers, surfactants, diluting agents, antifoaming agents, lubricants, leveling agents, water repellents, UV stabilizers, anti-blocking agents, optical brightening agents, dyes, pigments, colorants, and pH regulators.

The glitter sheet may be a glitter sheet for printing in which a water-based ink printed layer or an oil-based ink printed layer is formed on the coating layer described above.

The glitter sheet according to embodiments of the invention exhibits excellent print quality. Although the present invention is not limited to a particular printing method, for example, inkjet printing, offset printing, laser printing, gravure printing, flexo-printing, copy printing or the like may be adopted using a water-based ink or an oil-based ink.

Although curable printing such as latex printing or UV printing is also permitted, there can be a problem of reduction in cost reduction effects. On the contrary, the glitter sheet according to the embodiments can provide sufficiently high quality of printouts using an inkjet printer, an offset printer, a laser printer, a gravure printer, a flexo-printer, a copier, a domestic printer, and the like. Accordingly, the embodiments of the present invention can provide glitter sheets that can secure high print quality with low cost and can be advantageously used in various printing fields while satisfying various consumer demands.

Next, embodiments of the present invention will be described in more detail with reference to the accompanying drawings such that the present invention can be implemented by those skilled in the art.

It should be understood that the present invention can be embodied in various ways and is not limited to the accompanying drawings and embodiments described herein. Descriptions of details apparent to those skilled in the art are omitted herein, and like components are indicated by like reference numerals throughout the specification.

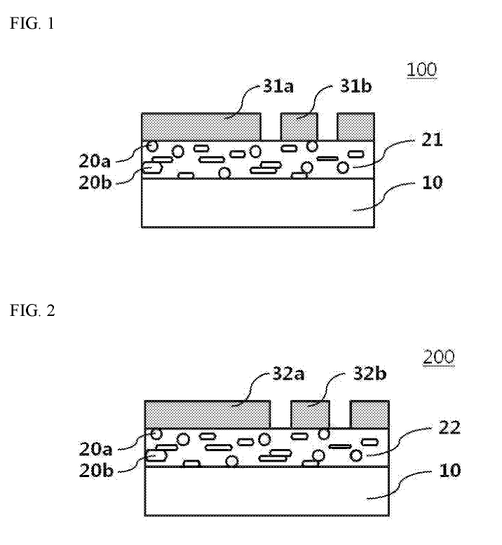

FIG. 1 is a sectional view of a glitter sheet 100 according to one embodiment of the present invention, on which an oil-based ink is printed. The glitter sheet 100 according to this embodiment includes a sheet supporter 10 and a coating layer 21 formed on the sheet supporter 10. The coating layer 21 includes porous particles 20a and glitter particles 20b. In addition, oil-based ink layers 31a, 31b may be printed on the coating layer 21. Specifically, the coating layer 21 may be formed of a coating composition that includes a glitter binder resin, porous particles 20a, and glitter particles 20b.

Some of the porous particles 20a and the glitter particles 20b may be exposed on a surface of the coating layer 21. In addition, although not shown, a portion of the coating layer 21 may intrude into the sheet supporter 10, and portions of the oil-based ink layers 31a, 31b may also intrude into the coating layer 21 or into pores of the porous particles 20a. As a result, the printed oil-based ink layers 31a, 31b can be rapidly absorbed and dried, and exhibit excellent adhesion to the coating layer while improving print quality of the glitter sheet.

The oil-based ink layers 31a, 31b may be printed by inkjet printing, offset printing, laser printing, gravure printing, flexo-printing, or copy printing.

FIG. 2 is a sectional view of a glitter sheet 200 according to one embodiment of the present invention, on which a water-based ink is printed. The glitter sheet 200 according to this embodiment includes a sheet supporter 10 and a coating layer 22 formed on the sheet supporter 10. The coating layer includes porous particles 20a and glitter particles 20b. In addition, water-based ink layers 32a, 32b may be printed on the coating layer 22. Specifically, the coating layer 22 may be formed of a coating composition that includes a glitter binder resin, a water-based ink-philic resin solution, porous particles 20a, and glitter particles 20b.

Some of the porous particles 20a and the glitter particles 20b may be exposed on a surface of the coating layer 22. In addition, although not shown, a portion of the coating layer 22 may intrude into the sheet supporter 10, and portions of the water-based ink layers 32a, 32b may also intrude into the coating layer 22 or into pores of the porous particles 20a. As a result, the printed water-based ink layers 32a, 32b can be rapidly absorbed and dried, and exhibit excellent adhesion to the coating layer while improving print quality of the glitter sheet.

The water-based ink layers 32a, 32b may be printed by inkjet printing, offset printing, laser printing, gravure printing, flexo-printing, or copy printing.

Now, the present invention will be described in more detail with reference to some examples. However, it should be noted that these examples are provided for illustration only and are not to be construed in any way as limiting the present invention.

### EXAMPLES

### Example 1

### Manufacture of Glitter Sheet having Oil-Based Ink Printability (Glitter Sheet for Oil-Based Ink Printing 1)

30 g of polyethylene vinyl acetate emulsion (DA-111, solid content: 55%, viscosity: 1,500˜2,500 mPa·S, glass transition temperature: 14° C.), 8 g of polyethylene vinyl acetate emulsion (DA-104, solid content: 55%, viscosity 2,000˜3,000 mPa·S, glass transition temperature: −15° C.), 42 g of glitter particles (Gelite glitter particles, TS330), 17 g of ground type calcium carbonate (D95, Keji. Co. Ltd., average particle diameter: 1.0˜2.0 μm), 2 g of diethylene glycol, 0.5 g of a water-based anionic dispersant (ZetaSperse 3600 Dispersant, Air Products and Chemicals, viscosity at 25° C.: 500 mPa·s, 52% effective component aqueous solution), and 0.5 g of a non-ionic wet dispersant (Disper BYK-192, BYK USA Inc., viscosity: ca.280 mPa·s) were placed in a reactor, followed by stirring at room temperature, thereby preparing a coating composition.

The prepared coating composition was deposited onto one surface of a 150 g/m² sheet supporter in a coating amount of 65 g/m² in terms of dry weight using a roll coating machine. Then, the coated sheet supporter was dried at 105° C. for 1 minute in a drying chamber.

A glitter sheet for oil-based ink printing was manufactured by the method described above.

### Example 2

### Manufacture of Glitter Sheet having Water-Based Ink Printability (Glitter Sheet for Water-Based Ink Printing 1)

15 g of polyethylene vinyl acetate emulsion (DA-111, solid content: 55%, viscosity: 1,500˜2,500 mPa·S, glass transition temperature: 14° C.), 15 g of polyethylene vinyl acetate emulsion (DA-104, solid content: 55%, viscosity 2,000˜3,000 mPa·S, glass transition temperature: −15° C.), 7 g of a polyvinyl alcohol solution (88% hydrolyzed, 18% solution), 42 g of glitter particles (Gelite glitter particles, TS330), 17 g of ground type calcium carbonate (D95, Keji. Co. Ltd., average particle diameter: 1.0˜2.0 μm), 2 g of diethylene glycol, 1 g of a cationic color-fixing agent (polyDADMAC 30%), 0.5 g of a water-based anionic dispersant (ZetaSperse 3600 Dispersant, Air Products and Chemicals, viscosity at 25° C.: 500 mPa·s, 52% effective component aqueous solution), and 0.5 g of a non-ionic wet dispersant (DisperBYK-192, BYK USA Inc., viscosity: ca.280 mPa·s) were placed in a reactor, followed by stirring at room temperature, thereby preparing a coating composition.

The prepared coating composition was deposited onto one surface of a 150 g/m² sheet supporter in a coating amount of 65 g/m² in terms of dry weight using a roll coating machine. Then, the coated sheet supporter was dried at 105° C. for 1 minute in a drying chamber.

A glitter sheet for water-based ink printing was manufactured by the method described above.

### Example 3

### Manufacture of Glitter Sheet having Oil-Based Ink Printability (Glitter Sheet for Oil-Based Ink Printing 2)

A coating composition was prepared in the same manner as in Example 1 except that 3 wt % of silica (Tianyinano, TYZ-507E, average particle diameter: 6˜8 μm) was used instead of calcium carbonate.

The prepared coating composition was deposited onto one surface of a 150 g/m² sheet supporter in a coating amount of 65 g/m² in terms of dry weight using a roll coating machine. Then, the coated sheet supporter was dried at 105° C. for 1 minute in a drying chamber.

An oil-based ink glitter sheet for printing was manufactured by the method described above.

### Example 4

### Manufacture of Glitter Sheet having Oil-Based Ink Printability (Oilglitter Sheet for based Ink Printing 3)

30 g of polyethylene vinyl acetate emulsion (DA-111, solid content: 55%, viscosity: 1,500˜2,500 mPa·S, glass transition temperature: 14° C.), 8 g of polyethylene vinyl acetate emulsion (DA-104, solid content: 55%, viscosity 2,000˜3,000 mPa·S, glass transition temperature: −15° C.), 42 g of glitter particles (Gelite glitter particles, TS330), 10 g of ground type calcium carbonate (D95, Keji. Co. Ltd., average particle diameter: 1.0˜2.0 μm), 5 g of precipitated type calcium carbonate (CAH-6150, Guangdong Qiangda Chemical Co. Ltd., average particle diameter: 4.0˜6.5 μm, precipitation volume: 2.5˜2.6 ml/g, pH 9˜10, oil absorption rate: 55 ml/100 g), 2 g of gel silica, 2 g of diethylene glycol, 0.5 g of a water-based anionic dispersant (ZetaSperse 3600 Dispersant, Air Products and Chemicals, viscosity at 25° C.: 500 mPa·s, 52% effective component aqueous solution), and 0.5 g of a non-ionic wet dispersant (DisperBYK-192, BYK USA Inc., viscosity: ca.280 mPa·s) were placed in a reactor, followed by stirring at room temperature, thereby preparing a coating composition.

The prepared coating composition was deposited onto one surface of a 150 g/m² sheet supporter in a coating amount of 120 g/m² in terms of dry weight using a roll coating machine. Then, the coated sheet supporter was dried at 105° C. for 1 minute in a drying chamber.

A glitter sheet for oil-based ink printing was manufactured by the method described above.

### Example 5

### Manufacture of Glitter Sheet having Water-Based Ink Printability (Glitter Sheet for Water-Based Ink Printing 2)

15 g of polyethylene vinyl acetate emulsion (DA-111, solid content: 55%, viscosity: 1,500˜2,500 mPa·S, glass transition temperature: 14° C.), 15 g of polyethylene vinyl acetate emulsion (DA-104, solid content: 55%, viscosity 2,000˜3,000 mPa·S, glass transition temperature: −15° C.), 42 g of glitter particles (Gelite glitter particles, TS330), 2 g of a polyvinyl alcohol solution (88% hydrolyzed, 18% solution), 5 g of a PVP solution (K-30, 30% solution), 10 g of ground type calcium carbonate (D95, Keji. Co. Ltd., average particle diameter: 1.0˜2.0 μm), 5 g of precipitated type calcium carbonate (CAH-6150, Guangdong Qiangda Chemical Co. Ltd., average particle diameter: 4.0˜6.5 μm, precipitation volume: 2.5˜2.6 ml/g, pH 9˜10, oil absorption rate: 55 ml/100 g), 2 g of gel silica, 2 g of diethylene glycol, 1 g of a cationic color-fixing agent (polyDADMAC 30%), 0.5 g of a water-based anionic dispersant (ZetaSperse 3600 Dispersant, Air Products and Chemicals, viscosity at 25° C.: 500 mPa·s, 52% effective component aqueous solution), and 0.5 g of a non-ionic wet dispersant (DisperBYK-192, BYK USA Inc., viscosity: ca.280 mPa·s) were placed in a reactor, followed by stirring at room temperature, thereby preparing a coating composition.

The prepared coating composition was deposited onto one surface of a 150 g/m² sheet supporter in a coating amount of 120 g/m² in terms of dry weight using a roll coating machine. Then, the coated sheet supporter was dried at 105° C. for 1 minute in a drying chamber.

A glitter sheet for water-based ink printing was manufactured by the method described above.

### Example 6

### Manufacture of Glitter Sheet further including Outermost Coating Layer having Oil-Based Ink Printability

20 g of ground type calcium carbonate (D95, Keji. Co. Ltd., average particle diameter: 1.0˜2.0 μm), 20 g of precipitated type calcium carbonate (CAH-6150, Guangdong Qiangda Chemical Co. Ltd., average particle diameter: 4.0˜6.5 μm, precipitation volume: 2.5˜2.6 ml/g, pH 9˜10, oil absorption rate: 55 ml/100 g), 20 g of silica gel (TYZ-507B, TianYi Nano-materials Tech. Co. Ltd., average particle diameter: 7 μm, oil absorption rate: 324 ml/100 g or more, pH 5.5, specific surface area: 280 m²/g or more), 4 g of diethylene glycol, 20 g of polyethylene vinyl acetate emulsion (DA-111, solid content 55%, viscosity 1,500˜2,500 mPa·S, glass transition temperature: 14° C.), 9 g of polyethylene vinyl acetate emulsion (DA-104, solid content 55%, viscosity: 2,000˜3,000 mPa·S, glass transition temperature: −15° C.), and 1 g of an anionic dispersant (ZetaSperse 3600), and 1 g of a non-ionic wet dispersant (BYK-192) were mixed to prepare a outermost layer coating composition.

An outermost layer coating composition was further deposited onto the coating layer of the glitter sheet prepare in Example 1, followed by drying (dry weight: 8 g/m²). Then, the outermost coating layer was subjected to embossing.

A glitter sheet for printing further including an outermost coating layer was manufactured by the method described above.

### Example 7

### Manufacture of Glitter Sheet further including Outermost Coating Layer having Water-Based Ink Printability

20 g of ground type calcium carbonate (D95, Keji. Co. Ltd., average particle diameter: 1.0˜2.0 μm), 20 g of precipitated type calcium carbonate (CAH-6150, Guangdong Qiangda Chemical. Co. Ltd., average particle diameter: 4.0˜6.5 μm, precipitation volume: 2.5˜2.6 ml/g, pH 9˜10, oil absorption rate: 55 ml/100 g), 20 g of silica gel, 20 g of polyethylene vinyl acetate emulsion (DA-111, solid content 55%, viscosity 1,500˜2,500 mPa·S, glass transition temperature: 14° C.), 5 g of a polyvinyl alcohol resin, 1.5 g of a cationic color-fixing agent (polyDADMAC 30%), 3 g of polyethylene vinyl acetate emulsion (DA-104, solid content 55%, viscosity: 2,000˜3,000 mPa·S, glass transition temperature: −15° C.), 1 g of an anionic dispersant (ZetaSperse 3600), and 1 g of a non-ionic wet dispersant (BYK-192) were mixed to prepare a outermost layer coating composition.

An outermost layer coating composition was further deposited onto the coating layer of the glitter sheet prepare in Example 1, followed by drying (dry weight: 8 g/m²). Then, the outermost coating layer was subjected to embossing treatment.

A glitter sheet for printing further including an outermost coating layer was manufactured by the method described above.

### Comparative Examples

### Comparative Example 1

A coating composition was prepared in the same manner as in Example 1 except that a polyvinyl alcohol resin was used in an amount of 41 wt % instead of the glitter binder resin.

The prepared coating composition was deposited onto one surface of a 150 g/m² sheet supporter in a coating amount of 10 g/m². Then, the coated sheet supporter was subjected to hot melting and glitter particles were deposited in an amount of 42 g/m² based on 100 parts by weight of the coating composition, thereby preparing a glitter sheet.

### Comparative Example 2

A coating composition was prepared in the same manner as in Example 2 except that a polyvinyl alcohol resin was used in an amount of 55 wt % instead of the glitter binder resin.

The prepared coating composition was deposited onto one surface of a 150 g/m² sheet supporter in a coating amount of 10 g/m². Then, the coated sheet supporter was subjected to hot melting and glitter particles were deposited in an amount of 42 g/m² based on 100 parts by weight of the coating composition, thereby preparing a glitter sheet.

### Comparative Example 3

A coating composition was prepared by mixing 23 wt % of a polyvinyl alcohol resin, 76 wt % of pigments, and 1 wt % of a cationic color-fixing agent.

The prepared coating composition was deposited onto one surface of a 150 g/m² sheet supporter in a coating amount of 10 g/m². Then, the coated sheet supporter was subjected to hot melting and glitter particles were deposited in an amount of 42 g/m² based on 100 parts by weight of the coating composition, thereby preparing a glitter sheet.

The glitter sheets prepared in Examples 1 to 7 and Comparatives 1 to 3 were evaluated as to properties by the following methods. Results are shown in Table 1.

<Property Evaluation>

1) Ink Absorptivity

Ink absorptivity was measured using a universal sample printer. In ink absorption testing, immediately after printing a glitter sheet with a standard printer ink, the printout was rubbed with general cloths and observed with the naked eye to determine degree of ink smearing.

Good: No ink smeared cloths

Poor: Ink smeared cloths

2) Print Quality

A glitter sheet was printed with a standard water-based ink and a standard oil-based ink using a universal sample printer. An enlarged boundary of a printed figure was photographed and was evaluated with the naked eye.

Very good: Smooth boundary and good image resolution without ink spreading due to absorption of ink into glitter sheet immediately after printing

Good: Smooth boundary and no ink spreading

Normal: No ink spreading despite non-smoothness boundary

Poor: Unclear boundary due to ink spreading

3) Adhesive Strength

A glitter sheet was cut into a specimen having a size of 0.5 m×0.5 m. On the specimen, 10 lines were drawn at constant intervals in each of longitudinal and transverse directions, following by repeatedly folding and unfolding the specimen 50 times at each portion at which the lines were drawn. Then, the weights of glitter particles and coating layer pieces detached from the sheet supporter were measured.

Good: 5 g/m² or less of detached glitter particles and coating layer pieces

Poor: more than 5 g/m² of detached glitter particles and coating layer pieces

4) Coefficient of Friction

Five specimens prepared from each of the glitter sheets prepared in Examples 4 to 5 and Comparative Example 1 were measured as to static coefficient of friction and kinetic coefficient of friction using a YQ0016/i-COFTEK330 under conditions of 23° C. and 50% RH in accordance with ASTM D1894-2014. Results are shown in Table 2.

TABLE 1

| | | Print quality: | Print quality: | |
|---|---|---|---|---|
| | Ink | oil-based ink | water-based ink | Adhesive |
| | absorptivity | printability | printability | strength |
| Example 1 | Good | Good | Normal | Good |
| Example 2 | Good | Normal | Good | Good |
| Example 3 | Good | Good | Good | Good |
| Example 4 | Good | Very good | Good | Good |
| Example 5 | Good | Good | Very good | Good |
| Example 6 | Good | Very good | Good | Good |
| Example 7 | Good | Good | Very good | Good |
| Comparative | Poor | Poor | Poor | Poor |
| Example 1 | | | | |
| Comparative | Poor | Poor | Normal | Poor |
| Example 2 | | | | |
| Comparative | Poor | Poor | Poor | Poor |
| Example 3 | | | | |

TABLE 2

| | Thickness of | Static coefficient | Kinetic coefficient |
|---|---|---|---|
| | specimen (μm) | of friction | of friction |
| Example 4 | 354 | 0.489 | 0.329 |
| Example 5 | 351.4 | 0.539 | 0.336 |
| Example 6 | 441.4 | 0.478 | 0.336 |
| Comparative | 379 | 0.756 | 0.486 |
| Example 1 | | | |

It should be understood that various modifications, changes, alterations, and equivalent embodiments can be made by those skilled in the art without departing from the spirit and scope of the invention.

### LIST OF REFERENCE NUMERALS

10: Sheet supporter

21, 22: Coating layer

20a: Porous particles

20b: Glitter particles

31a, 31b: Oil-based ink layer

32a, 32b: Water-based ink layer

1. A coating composition for glitter sheets, comprising:
a binder resin comprising at least one of vinyl acetate-ethylene resins, polyvinyl acetate resins, acrylic resins, styrene-butadiene rubber (SBR), nitrile rubber, acrylic rubber or urethane resins;
glitter particles; and
porous particles.

2. The coating composition for glitter sheets according to claim 1, comprising: about 20 wt % to about 60 wt % of the glitter binder resin, about 10 wt % to about 60 wt % of the glitter particles, and about 1 wt % to about 30 wt % of the porous particles.

3. The coating composition for glitter sheets according to claim 1, wherein the porous particles comprise at least one of silica particles, calcium silicate particles, calcium carbonate particles, calcium sulfate particles, alumina particles, aluminum silicate particles, kaolin particles, talc particles, mica particles, dolomite particles, plaster particles, clay particles, titanium oxide particles, or porous polymer particles.

4. The coating composition for glitter sheets according to claim 1, wherein the glitter binder resin is a mixture of about 30 wt % to about 70 wt % of a first binder resin having a glass transition temperature of about 0° C. to about 70° C. and about 30 wt % to about 70 wt % of a second binder resin having a glass transition temperature of less than about 0° C. to about −50° C., and the coating composition exhibits oil-based ink printability.

5. The coating composition for glitter sheets according to claim 1, further comprising:
at least one hydrophilic resin of polyvinyl alcohol, polyvinyl alcohol-acetate copolymers, polyvinyl pyrrolidone, water-soluble acrylic resins, starch, gelatin or cellulose resins,
wherein the glitter binder resin is a mixture of about 45 wt % to about 95 wt % of a first binder resin having a glass transition temperature of about 0° C. to about 70° C. and about 5 wt % to about 50 wt % of a second binder resin having a glass transition temperature of less than about 0° C. to about −50° C., and the coating composition exhibits water-based ink printability.

6. The coating composition for glitter sheets according to claim 1, further comprising: at least one additive selected from among bonding aids, cationic color-fixing agents, crosslinking agents, dispersants, thickening agents, wetting agent, preserving agents, plasticizers, surfactants, diluting agents, antifoaming agents, lubricants, leveling agents, water repellents, UV stabilizers, anti-blocking agents, optical brightening agents, dyes, pigments, colorants, and pH regulators.

7. A glitter sheet for printing, comprising:
a sheet supporter; and
a glitter coating layer formed on the sheet supporter,
wherein the glitter coating layer comprises:
a binder resin comprising at least one of vinyl acetate-ethylene resins, polyvinyl acetate resins, acrylic resins, styrene-butadiene rubber (SBR), nitrile rubber, acrylic rubber and urethane resins;
glitter particles; and
porous particles.

8. The glitter sheet for printing according to claim 7, further comprising:
an outermost coating layer formed on the glitter coating layer, the outermost coating layer comprising a glitter binder resin and porous particles.

9. The glitter sheet for printing according to claim 7, wherein the glitter sheet for printing has a static coefficient of friction of about 0.2 to about 0.8 and a kinetic coefficient of friction of about 0.1 to about 0.5.

10. A method for manufacturing a glitter sheet, comprising:
depositing a coating composition on a sheet by roll coating, the coating composition comprising:
a binder resin comprising at least one of vinyl acetate-ethylene resins, polyvinyl acetate resins, acrylic resins, styrene-butadiene rubber (SBR), nitrile rubber, acrylic rubber and urethane resins;
glitter particles; and
porous particles; and
drying the coating composition to form a glitter coating layer.

11. The glitter sheet according to claim 7, wherein the glitter coting layer comprises: about 20 wt % to about 60 wt % of the glitter binder resin, about 10 wt % to about 60 wt % of the glitter particles, and about 1 wt % to about 30 wt % of the porous particles.

12. The glitter sheet according to claim 7, wherein the porous particles comprise at least one of silica particles, calcium silicate particles, calcium carbonate particles, calcium sulfate particles, alumina particles, aluminum silicate particles, kaolin particles, talc particles, mica particles, dolomite particles, plaster particles, clay particles, titanium oxide particles, or porous polymer particles.

13. The glitter sheet according to claim 7, wherein the binder resin is a mixture of about 30 wt % to about 70 wt % of a first binder resin having a glass transition temperature of about 0° C. to about 70° C. and about 30 wt % to about 70 wt % of a second binder resin having a glass transition temperature of less than about 0° C. to about −50° C., and the glitter coating layer exhibits oil-based ink printability.

14. The glitter sheet according to claim 7, further comprising:
at least one hydrophilic resin of polyvinyl alcohol, polyvinyl alcohol-acetate copolymers, polyvinyl pyrrolidone, water-soluble acrylic resins, starch, gelatin or cellulose resins,
wherein the binder resin is a mixture of about 45 wt % to about 95 wt % of a first binder resin having a glass transition temperature of about 0° C. to about 70° C. and about 5 wt % to about 50 wt % of a second binder resin having a glass transition temperature of less than about 0° C. to about −50° C., and the glitter coating layer exhibits water-based ink printability.

15. The glitter sheet according to claim 7, further comprising: at least one additive selected from among bonding aids, cationic color-fixing agents, crosslinking agents, dispersants, thickening agents, wetting agent, preserving agents, plasticizers, surfactants, diluting agents, antifoaming agents, lubricants, leveling agents, water repellents, UV stabilizers, anti-blocking agents, optical brightening agents, dyes, pigments, colorants, and pH regulators.
